(19) United States
(12) Patent Application Publication
(10) Pub. No.: US 2009/0304839 A1
(43) Pub. Date: Dec. 10, 2009

(54) REMOTE-SUPERVISORY FLASKLESS MOLDING MACHINE

(76) Inventor: Minoru Hirata, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/915,193

(22) PCT Filed: May 23, 2006
(86) PCT No.: PCT/JP2006/310207

§ 371 Date: Feb. 3, 2009

(51) Int. Cl. B29C 43/58

(52) U.S. Cl. 425/147

(57) ABSTRACT

A remote-supervisory flaskless molding machine, wherein the fluid pressures of first fluid cylinders (122) and (123) moving a cope (102) and a drag (103) close to and apart from each other, a second fluid cylinder (110) rotating the cope, the drag, and a match plate (105), a third fluid cylinder (129) separating an upper flask from the match plate, and a fourth fluid cylinder (138) extracting the cope and the drag from the upper flask (102) and a lower flask (103) in pairs and the pressure of a compressed air in a filling mechanism (11) filing a foundry sand to the upper and lower flasks by the compressed air are measured by sensors. The measured values by these sensors are transmitted to a monitoring tool (32) by a transmitter (31) through the Internet or an intranet (33) where these values are analyzed and the analyzed results are displayed.

### FIELD OF THE INVENTION

This invention relates to a flaskless molding machine in which flasks are removed from previously stacked molds that have been made within the flasks, and in particular to such a machine that is suitable for operating under a remote monitoring.

### BACKGROUND OF THE INVENTION

For instance, WO2005/089983 A1, assigned to the assignee of the present application, proposes a flaskless molding machine that is adapted to be actuated with hydraulic pressure. In this flaskless molding machine, its driven parts (e.g., the cope and drag flasks for use in molding processes) are primarily driven by means of hydraulic drives. Thus a plurality of hydraulic-cylinder systems is provided. Such a flaskless molding machine also uses compressed air or hydraulic fluid to fill the cope and drag flasks with molding sand to make molds. Typically, a sand-filling device injects the molding sand into the cope and drag flasks by the compressed air, while the molding sand within the sand-filling device is fluidized by further compressed air.

The conventional flaskless molding machine involves neither a particular method nor equipment to provide quantitative diagnostics to determine if the hydraulic-cylinder systems, the sand-filling device, and so on are in their normal operating states. Monitoring these operating states thus should rely on a human operator's observation around the molding machine.

### SUMMARY OF THE INVENTION

Accordingly, one object of the present invention is to provide a flaskless molding machine that enables accurate monitoring of the operating states of it at remote locations.

The present invention provides a flaskless molding machine for making flaskless upper and lower molds. The molding machine comprises:

a cope flask and a drag flask, each flask defining an opening in which the corresponding mold to be made and having at least one sand-supplying port to supply the molding sand to said opening, wherein the cope flask and the drag flask are supported such that they can be moved close to and away from each other;

a first cylinder system adapted to be actuated by variable hydraulic pressure for generating a driving force to cause the cope and drag flasks to be moved close to and away from each other;

a match plate having top and bottom faces, wherein the match plate is provided to be carried in and carried out between the cope and drag flasks;

upper and lower squeeze members, each member being insertable into the corresponding flask, while each member is opposed to the corresponding face of the match plate when the match plate is held between the cope and drag flasks in a sandwiched relationship, such that molding sand to be filled within the flasks is being squeezed;

a second cylinder system adapted to be actuated by a variable hydraulic pressure for generating a driving force to cause the cope flask, the drag flask, and the match plate that is held therebetween to be rotated in unison between a position where the cope and drag flasks and the match plate are in their vertical positions and a position where the cope and drag flasks and the match plate are in their horizontal positions;

sand-supplying means, having a source of compressed air, for blowing the molding sand through the sand supplying ports of the cope and drag flask by the compressed air such that the cope and drag flasks in the vertical positions are filled with the molding sand;

measuring means that includes a plurality of sensors for measuring at least fluid pressures of the first and second cylinder systems, and air pressure of the compressed air supplied from the source, respectively,

transmitting means for transmitting the measured values from the measuring means on a communication link; and

analyzing means for receiving and analyzing the transmitted measured values, and for displaying the results of the analysis.

The sand-supplying means may also fluidize the molding sand by compressed air with a variable pressure from the source or an optional source, while said flasks are filled with the molding sand. In this case, the measuring means also includes a sensor for measuring the air pressure of the compressed air used for the fluidizing of the molding sand.

The sensors of the measuring means may include a sensor for detecting the top level of the molding sand within the sand-supplying means.

The communication link may be by the Internet or the Intranet.

Each cylinder system includes clustered cylinders that are composed of a plurality of hydraulic cylinders. The hydraulic pressure of each cylinder system is an oil pressure or a pneumatic pressure.

The molding machine may further include an optional cylinder system that is adapted to be actuated by variable hydraulic pressure for providing a driving force to a driven part of the flaskless molding machine. In this case, the sensors of the measuring means further include a sensor for measuring the hydraulic pressure of the optional cylinder system.

For example, the optional cylinder system provides the driving force to the upper and lower squeeze members.

The flaskless molding machine may be adapted to use two pairs of flasks, in which one cope flask and one drag flask are formed as one pair such that the molding machine is adapted to alternately make molds with the two pairs of flasks. In this case, the optional cylinder system includes a third cylinder system for generating a driving force to remove said cope flask that is used to make the upper mold, which is contained therein, from the match plate, and a fourth cylinder system for generating a driving force to strip the upper and lower molds from the one pair of flasks that has been separated from the match plate.

The optional cylinder system may include clustered cylinders that comprise a plurality of hydraulic cylinders.

### BRIEF DESCRIPTION OF THE DRAWINGS

FIG. 1 shows a front view of the flaskless molding machine of the first embodiment of the present invention.

FIG. 2 shows a plane view, partly in cross section, of the molding machine of FIG. 1.

FIG. 3 shows a front view of the flaskless molding machine of the second embodiment of the present invention.

FIG. 4 shows a plane view, partly in cross section, of the molding machine of FIG. 3.

### THE PREFERRED EMBODIMENTS OF THE PRESENT INVENTION

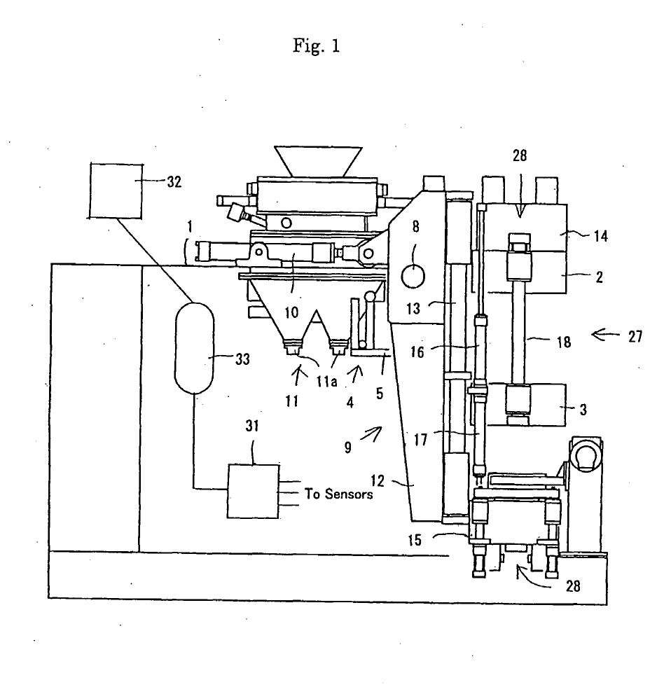

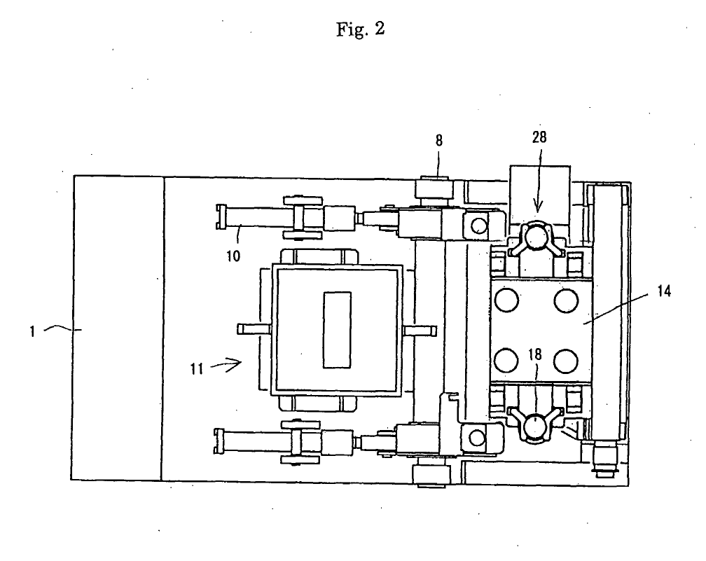

FIGS. 1 and 2 illustrate a first embodiment of the flaskless molding machine for making flaskless upper and lower molds of the present invention. This molding machine includes a rectangular machinery mount 1. Located at the right side of the machinery mount 1 is a flask unit 27, which comprises a cope flask 2, a drag flask 3, and a pair of connecting rods 18 for interconnecting the flasks 2, 3 to each other such that they can be moved close to and away from each other. Each flask, whose sidewall has a sand-filling port, defines an opening. In the embodiment, the connecting rods 18 are suspended from the cope flask 2, whereas the drag flask 3 is mounted on the connecting rods 18 such that it can be lowered by a predetermined distance from the cope flask 2.

The molding machine also includes a shuttle 4 for carrying in a match plate 5 between the cope flask 2 and the drag flask 3 of the flask unit 27 and for carrying out it therefrom, and a squeezing mechanism 9. Both faces of the match plate 5 have patterns.

The flask unit 27 is releasably attached to the squeezing mechanism 9 by means of a pair of dampers 28. The squeezing mechanism 9 is provided with upper and lower squeezing members (not shown) that are insertable in and drawable from the corresponding openings of the cope flask 2 and the drag flask 3, respectively. These openings are opposed to the match plate 5 when it is held between the paired flasks 2 and 3. Each squeezing member may be, e.g., a squeeze plate, or squeeze feet, in which a plurality of squeeze foots are arranged, and so on. They are well known to one skilled in the art. The squeezing mechanism 9 is rotatably supported by a supporting shaft 8. It stands on the center of the upper portion of the machinery mount 1. The squeezing mechanism 9 is thus reversibly turnable about the supporting shaft 8 in a normal plane. The squeezing mechanism 9 has a turning range between a position where the paired cope and drag flasks 2 and 3 and the held match plate 5 therebetween are in their vertical positions, and a position where they are in their horizontal positions. The molding machine also includes a pair of horizontal, hydraulic cylinders (a second hydraulic cylinder system) 10, each of which is adapted to be actuated by variable hydraulic pressure, for reversibly turning the squeezing mechanism 9. Mounted on the upper left of the machinery mount 1 is a sand-supplying device 11. Beneath it, a pair of supplying sources (not shown) of compressed air is provided. The device 11 blows the molding sand into the paired cope and drag flasks 2 and 3, which are already positioned in their vertical positions by the extending motions of the hydraulic cylinders 10, through one or more sand-filling ports (not shown). The sand-filing ports are provided on the respective flasks to introduce the molding sand therein by means of the compressed air with a variable pressure supplied from the sources. While the molding sand is blown and introduced to the paired flasks, the molding sand may be floated or fluidized by the compressed air with the variable pressure from the supplying source for blowing the molding sand, or another supplying source or sources of compressed air.

In the squeezing mechanism 9, a rotating frame 12 is rotatably supported by the supporting shaft 8 such that the frame 12 is reversibly turnable about the shaft 8 in a normal plane. The right side of the frame 12 is provided with a pair of vertically extending, guiding rods 13 that are positioned in a rear and front relation to each other to form a predetermined interval therebetween. An upper vertically-moving frame 14 and a lower vertically-moving frame 15 are vertically and slidably suspended from and across the upper portions and the lower portions, respectively, of two guiding rods 13. The upper and lower vertically-moving frames 14 and 15 are reciprocately moved in that they approach each other and move away from each other by extending and contracting motions of hydraulic cylinders (first hydraulic cylinder system) 16 and 17, each of which is mounted on the frame 12 and is actuated by variable hydraulic pressure.

The molding machine also includes a plurality of sensors for measuring the variable hydraulic pressures (that include an oil pressure or a pneumatic pressure) of the hydraulic cylinders 16, 17 for driving driven parts in the molding machine and the hydraulic cylinders 10, and for detecting the variable pressures of the compressed air that blows the molding sand into the molding space to fill it with the molding sand (and the compressed air to float or fluidize the molding sand, if required) used by the sand-supplying device 11. As in FIG. 1, these sensors are electrically connected to a transmitter 31 to transmit their measured values. (The sensors are illustrated as lines extended from the transmitter 31, for the sake of simplifying the drawing.) The transmitter 31 communicates with a monitoring tool 32 for analyzing the measured values from the sensors and displaying the result of the analysis, through a communication link 33, which includes, e.g., the Internet or Intranet. The sensors connected to the transmitter 31 may include a sensor for detecting an upper level of the molding sand within the sand-supplying device 11, if desired.

In the flaskless molding machine configured as described above, first, the match plate 5 is carried in between the cope flask 2 and the drag flask 3 in their horizontal positions by means of the shuttle 4. The hydraulic cylinders 16 and 17 are then contracted such that the match plate 5 is held between the cope flask 2 and the drag flask 3, with a sandwiched relation. The hydraulic cylinders 10 are then extended to rotate the squeezing mechanism 9 to cause the cope flask 2, the drag flask 3, and the match plate 5 to be in their vertical positions, with the sand-filling ports of the cope and drag flasks 2 and 3 abutting two injectors 11a, each of which injects the molding sand, of the sand-filling device 11, respectively. In this state, the upper squeezing member and the lower squeezing member are inserted in the cope flask 2 and the drag flask 3 in the predetermined lengths to define the upper and lower molding spaces. The upper (or lower) molding space is defined by the upper (or lower) squeezing member, the cope flask 2 (or the drag flask 3), and the match plate 5.

The sand-filling device 11 then blows the molding sand to fill the upper and lower molding spaces with the molding sand (while the molding sand is floated or fluidized, if desired). Consequently, the upper and lower squeezing members are then actuated to squeeze the molding sand within the upper and lower molding spaces. The hydraulic cylinders 10 are then contracted to move back the cope flask 2, the drag flask 3, and the match plate 5 in their horizontal positions. The hydraulic cylinders 16 and 17 are then extended to lift the cope flask 2 and to lower the drag flask 3 so as to separate the match plate 5 from the cope and drag flasks 2 and 3, with the drag flask 3 being suspended from the connected rods 18. The shuttle 4 then removes the match plate 5 from between the cope flask 2 and the drag flask 3. The hydraulic cylinders 16 and 17 are then contracted to lower the cope flask 2 and to lift the drag flask 3 such that they are stacked. The upper and lower squeezing members are then actuated, while the hydraulic cylinders 16 and 17 are extended to lift the cope flask 2 and to lower the drag flask 3. Consequently, an upper mold and a lower mold that have been made in the cope flask 2 and the drag flask 3 are removed therefrom, with the drag flask 3 being suspended from the connecting rods 18.

Upon the upper and lower flaskless molds being produced as in the above manner, the respective sensors measure the hydraulic pressure (that includes an oil pressure or a pneumatic pressure) of the respective hydraulic cylinders 10, 16, and 17 to drive the corresponding driving parts in the molding machine, or measure the pressure of the compressed air to blow the molding sand into the molding space to fill them with the molding sand (and the compressed air to float or fluidize the molding sand, if required) used by the sand-supplying device 11 (or measures the upper level of the molding sand within the sand-supplying device 11, if desired). These measured values from the sensors are provided in the monitoring tool 32 by means of the transmitter 31 through the communication link 33. The monitoring tool 32 analyzes the measured values and displays the results of the analysis. The monitoring tool 32 may comprise a computer with a display to indicate the results of the analysis, and software running on the computer to analyze the measured values from the sensors and to cause the results of the analysis to be displayed. The results of the analysis may include, e.g., a determination of whether the respective measured value is in the predetermined allowable range. If any measured value is outside the predetermined allowable range, visual sign or an auditory signal, or both, may generate alert indication(s), for example. In addition, the monitoring tool 32 may also include a printer and so forth to output the results of the analysis.

Because such a monitoring tool 32 can be placed apart from the machinery mount 1 on which the machinery components of the molding machine are arranged, any operating condition of the molding machine can be remotely monitored.

Although this embodiment employs the hydraulic cylinders (the first hydraulic cylinder system) 16 and 17 for causing the cope flask 2 and the drag flask 3 to approach each other and retract from each other, the hydraulic cylinders (the second hydraulic cylinder system) 10 for rotating the cope flask 2, the drag flask 3, and the match plate 5, as the hydraulic cylinder system to drive the driven elements in the flaskless molding machine, the present invention is not limited to them. If the flaskless molding machine further includes an optional hydraulic cylinder system to drive an optional driven part, an optional sensor for measuring the hydraulic pressure of the additional hydraulic cylinder system may be provided such that the measured value from the optional sensor is provided in the monitoring tool 32 by means of the transmitter 31, through the communication link 33, in the forgoing manner.

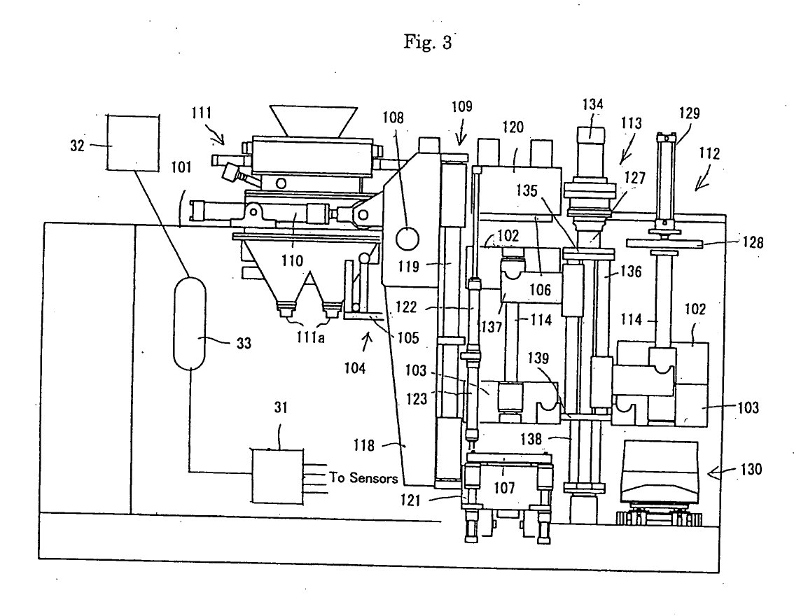

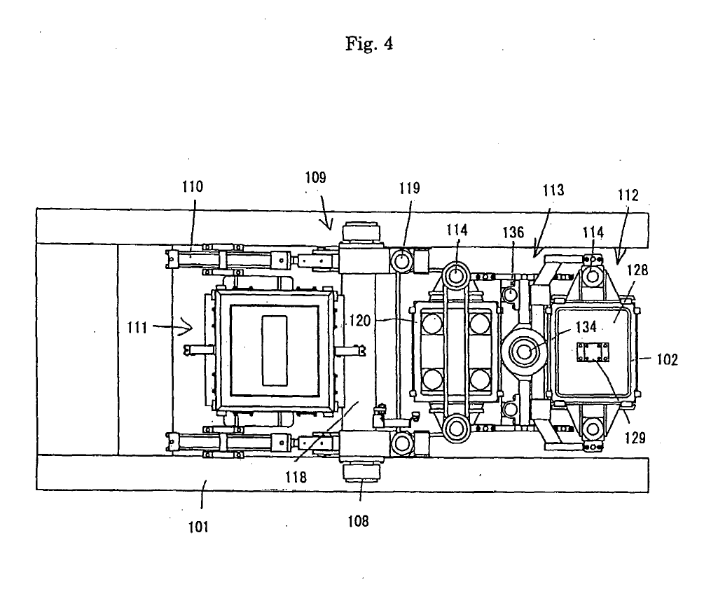

FIGS. 3 and 4 show the second embodiment of the present invention of the flaskless molding machine. It includes an optional cylinder system.

The major difference between the first and the second embodiments of the molding machines is that the second embodiment employs two pairs of the flasks, in which each pair comprises one cope flask 102 and one drag flask 103, while the first embodiment employs the single flask unit 27, in which one cope flask 2 and one drag flask 3 are connected to each other. Associated with such an arrangement, the flaskless molding machine of the second embodiment also includes a third hydraulic cylinder 129 to separate the cope flask 102 from the match plate 5, and a fourth hydraulic cylinder 138 to strip an upper mold and a lower mold from the pairs of flasks 102, 103.

The flaskless molding machine of the second embodiment includes a machinery mount 101, a shuttle 104, a match plate 105, a supporting shaft 108, a squeezing mechanism 109, hydraulic cylinders (the second cylinder system) 110, and a sand-filling device 111. They are similar to the machinery mount 1, the shuttle 4, the match plate 5, the supporting shaft 8, the squeezing mechanism 9, the hydraulic cylinders (the second hydraulic cylinder system) 10, and the sand-filling device 11, in the first embodiment, respectively. As described above, on the right side of the machinery mount 101, two pairs of the cope flasks 102 and the drag flasks 103, each flask defining an opening and having a sand-supplying port or ports in its sidewall, are arranged. Each pair of the flasks (the cope flask 102 and the drag flask 103) are slidably mounted on the connecting rods 114.

In one pair of the two pairs of flasks, the match plate 105, both faces of which are provided with a pattern, is placed between the cope flask 102 and the drag flask 103 such that it can be carried in therebetween and carried out from therebetween by means of the shuttle 104. The squeezing mechanism 109 includes an upper squeezing member 106 and a lower squeezing member 107. Both members are arranged such that they can be inserted in and drawn from the corresponding openings that are located opposite the match plate 105 of the cope and drag flasks 102 and 103, with the match plate 105 being held between the paired flasks (the cope and drag flasks 102 and 103). The squeezing mechanism 109 supports the paired cope and drag flasks 102 and 103. The match plate 105 is held therebetween in a sandwiched relation such that they reversibly rotate between a vertical position where they are in their vertical positions, and a horizontal position where they are in their horizontal positions, in the vertical plane about the supporting shaft 108, which stands on the machinery mount 101. This reversibly rotating motion of the squeezing mechanism 109 is carried out by actuating the hydraulic cylinders 110. The paired cope and drag flasks 102 and 103, which have been in their vertical positions by means of the extended motions of the hydraulic cylinders 110, are filled with the molding sand that is blown and injected from the sand-filling ports on the flasks, by means of the compressed air. The molding sand may also be floated or fluidized by means of the compressed air, in the second embodiment.

In contrast to the flaskless molding machine of the first embodiment, the flaskless molding machine of the second embodiment further includes mold-stripping equipment 112 and a pivoting mechanism 113 for pivoting the flasks.

The mold-stripping equipment 112 strips the upper and lower molds from one pair of cope and drag flasks 102 and 103, which are stacked in their horizontal positions such that they contain the corresponding molds. To this end, the mold-stripping equipment 112 includes an extruding plate 128 that is insertable between the stacked cope and drag flasks 102 and 103 in their horizontal positions. The extruding plate 128 is attached to the lower end of a piston rod of the hydraulic cylinder (the fourth hydraulic cylinder) 129 that is mounted on the machinery mount 101. Located immediately beneath the extruding plate 128 is a receiver 130 for receiving the upper and lower molds, which are stripped from the cope and drag flasks 102 and 103.

The pivoting mechanism 113 alternatively and intermittently rotates two paired cope and drag flasks 102 and 103, in which one pair and another pair are disposed in a vertical line. Each pair of flasks is composed of one cope flask 102 and the drag flask 103 that are stacked in their horizontal positions. The pivoting mechanism 113 can be lifted and lowered, while it is engaged with the cope flask 102.

In the pivoting mechanism 113, a vertically extended, rotary shaft 127 is horizontally and rotatably mounted on the machinery mount 101. The upper end of the rotary shaft 127 is attached to an output shaft of a motor 134, which is mounted on the upper portion of the machinery mount 101. Provided with the rotary shaft 127 slightly above the height-wise center of it is a supporting member 135. Two pairs of extended guiding rods 136 are downwardly suspended from the supporting member 135 with a predetermined interval between one pair of guiding rods 136 in the crosswise direction of the molding machine. The two pair of guiding rods 136 are opposed to each other in the length direction about the rotary shaft 127. An upper engaging member 137 is vertically and slidably attached on each pair of the guiding rods 136 to engage lugs that are formed on the cope flask 102. Each upper engaging member 137 is attached to the distal end of the piston rod of the hydraulic cylinder (the third hydraulic cylinder system) 138, which is mounted on the rotary shaft 127. Each upper engaging member 137 can thus be vertically moved by the extending and contracting motions of the corresponding cylinder 138. The lower ends of the two pairs of the guiding rods 136 are attached to a lower engaging member 139 that can be engaged to the lugs of the two drag flasks 103.

The arrangement of the squeezing mechanism 109 is similar to the squeezing mechanism 9 of the first embodiment. The squeezing mechanism 109 includes a rotating frame 118 that is rotatably supported by a supporting shaft 108, which stands on the center of the upper portion of the machinery mount 101. The right side of the rotating frame 118 is provided with a pair of vertical, extended guiding rods 119 that are positioned in a rear and front relation to each other to form a predetermined distance therebetween. An upper vertically-moving frame 120 and a lower vertically-moving frame 121 are vertically and slidably mounted on and across the upper portions and the lower portions, respectively, of two guiding rods 119. The upper vertically-moving frame 120 and a lower vertically-moving frame 121 can be moved close to and away from each other by the extending and contracting motions of the hydraulic cylinders (the first cylinder system) 122, 123.

The arrangement of the sand-supplying device 111 is also similar to the sand-supplying device 11 of the first embodiment. The sand-supplying device 111 is mounted on the upper left portion of the machinery mount 101 such that two sources (not shown) of compressed air are provided beneath the sand-supplying device 111.

The molding machine also includes a plurality of sensors for measuring the variable hydraulic pressures (that include an oil pressure or a pneumatic pressure) of the hydraulic cylinders 110, 122, 123, 129, and 138 to drive driven elements in the molding machine, and for detecting the variable pressures of the compressed air to blow and fill the molding sand into the molding space (and the compressed air to float or fluidize the molding sand, if required) used by the sand-supplying device 111. As shown in FIG. 3, the sensors are illustrated as lines extending from the transmitter 31 to simplify the drawing. Similar to the first embodiment, the measured values from the sensors are provided to the monitoring tool 32 by means of the transmitter 31, which is electrically connected to the sensors, through the communication link 33, in order to analyze the measured values and to display the result of the analysis.

The sensors connected to the transmitter 31 may include a sensor for detecting the upper level of the molding sand within the cope and drag flasks 102 and 103.

In the flaskless molding machine configured as described above, first, the match plate 105 is carried in between the cope flask 102 and the drag flask 103 in their horizontal positions by means of the shuttle 104. The hydraulic cylinders 122 and 123 are then contracted such that the match plate 105 is held between the cope flask 102 and the drag flask 103 in a sandwiched relation. The upper squeezing member 106 and the lower squeezing member 107 are then actuated and inserted in the cope flask 102 and the drag flask 103, respectively, by the predetermined lengths, to define an upper molding space and a lower molding space. The hydraulic cylinders 110 are then extended to rotate the squeezing mechanism 109 such that the cope flask 102, the drag flask 103, and the match plate 105 are in their vertical positions, with each sand filling port of each flask abutting the respective injectors 111a, which injects the molding sand, of the sand-filling device 111.

The sand-filling device 111 then blows the molding sand to fill the upper and lower molding spaces with the molding sand (while the molding sand is floated or fluidized, if desired). Consequently, the upper squeezing member 106 and the lower squeezing member 107 are then actuated to squeeze the molding sand within the upper and lower molding spaces.

The hydraulic cylinders 110 are then contracted to move the cope flask 102, the drag flask 103, and the match plate 105 back to their horizontal positions. The hydraulic cylinders 122 and 123 are then extended such that the upper vertically-moving frame 120 and the lower vertically-moving frame 121 moves away from each other. The cylinder 138 is then extended to suspend the cope flask 102, which contains the resulting mold, from the upper engaging member 137, to lift the cope flask 102 such that it is separated from the match plate 105. At this time, the drag flask 103 is displaced on the lower engaging member 139 of the pivoting mechanism 113. The match plate 105 is then carried out from between the cope flask 102 and the drag flask 103. The motor 134 is then activated to rotate the rotary shaft 127 by the predetermined angle of the rotation to pivotally move the cope flask 102 and the drag flask 103 to the mold-stripping equipment 112. The hydraulic cylinder 129 is then actuated to drive the mold-stripping equipment 112 such that the upper mold and the lower mold are stripped from the cope flask and the drag flask, respectively.

When the upper and lower flaskless molds are made in the above manner, the respective sensor measures the hydraulic pressure (that includes an oil pressure or a pneumatic pressure) of each hydraulic cylinder to drive the corresponding driving element in the molding machine, or measures the pressure of the compressed air to blow and fill the molding sand into the molding space (and the compressed air to float or fluidize the molding sand, if required) used by the sand-supplying device 111, or measures the upper level of the filled molding sand, if desired). In the second embodiment, the cylinder systems that are adapted to be actuated by variable hydraulic pressures to drive the driven elements of the molding machine include the hydraulic cylinders (the first hydraulic cylinder system) 122 and 123 for causing the cope flask 102 and the drag flask 103 to be moved close to and away from each other, the hydraulic cylinder (the second hydraulic cylinder system) 110 for rotating the cope flask 102, the drag flask 103, and the match plate 105, the hydraulic cylinder (the third hydraulic cylinder system) 129, and the fourth hydraulic cylinder 138 for stripping the upper and lower molds from the cope and drag flasks 102 and 103.

Similar to the first embodiment, the measured values from the sensors are provided in the monitoring tool 32 by means of the transmitter 31 through the communication link 33 such that the monitoring tool 32 analyzes the measured values and displays the results of the analysis. The monitoring tool 32 may comprise a computer with a display to indicate the results of the analysis, software running on the computer to analyze the measured values from the sensors, and to cause the results of the analyses to be displayed.

Because the monitoring tool 32 can be placed apart from the machinery mount 101 on which machinery components of the molding machine are arranged, any operating condition of the molding machine can be remotely monitored, similar to the first embodiment.

The disclosed embodiments are just intended for illustrative purposes. Thus the present invention is not limited to them. For example, if the upper and squeezing members of the first embodiment, or the upper squeezing member 106 and the lower squeezing member 107 of the second embodiment, are driven by means of cylinder systems that are adapted to be actuated by variable hydraulic pressures, the cylinder systems may be provided with the corresponding sensors in order to monitor the operating states of them. Further, each cylinder system may include an arbitrary number of cylinders or just one cylinder. For example, each cylinder system may include clustered cylinders that are comprised of a plurality of cylinders. Alternatively, any cylinder system may include just one cylinder, if it has a sufficient output power.

1. A flaskless molding machine for making flaskless upper and lower molds, comprising:
a cope flask and a drag flask, each flask defining an opening in which the corresponding mold to be made has at least one sand-supplying port to supply the molding sand to said opening, wherein said cope flask and said drag flask are supported such that they can be moved close to and away from each other;
a first cylinder system adapted to be actuated by a variable hydraulic pressure for generating a driving force to cause said cope and drag flasks to be moved close to and away from each other;
a match plate having top and bottom faces, wherein said match plate is provided to be carried in and carried out between said cope and drag flasks;
upper and lower squeeze members, each member being insertable into the corresponding flask, while each member is opposed to the corresponding face of said match plate when said match plate is held between said cope and drag flasks in a sandwiched relationship, such that molding sand to be filled within said flasks is being squeezed;
a second cylinder system adapted to be actuated by variable hydraulic pressure for generating a driving force to cause said cope flask, said drag flask, and said match plate that is held therebetween to be rotated in unison between a position where said cope and drag flasks and said match plate are in their vertical positions and a position where said cope and drag flasks and said match plate are in their horizontal positions;
sand-supplying means, having a source of compressed air, for blowing the molding sand through said sand supplying ports of said cope and drag flask by the compressed air such that said cope and drag flasks in said vertical positions are filled with the molding sand;
measuring means that includes a plurality of sensors for measuring at least fluid pressures of said first and second cylinder systems, and air pressure of said compressed air supplying from said source, respectively,
transmitting means for transmitting the measured values from said measuring means on a communication link; and
analyzing means for receiving and analyzing the transmitted measured values, and for displaying the results of the analysis.

2. The flaskless molding machine of claim 1, wherein said sand-supplying means also fluidizes the molding sand by compressed air with variable pressure from said source or an optional source while said flasks are filled with the molding sand, and wherein said measuring means also includes a sensor for measuring air pressure of said compressed air used for said fluidizing of the molding sand.

3. The flaskless molding machine of claim 1, wherein said measuring means further include a sensor for detecting the top level of the molding sand within said sand-supplying means.

4. The flaskless molding machine of claim 1, wherein said communication link is the Internet or Intranet.

5. The flaskless molding machine of claim 1, wherein each cylinder system includes clustered cylinders that are composed of a plurality of hydraulic cylinders.

6. The flaskless molding machine of claim 5, wherein said hydraulic pressure of each cylinder system is an oil pressure or a pneumatic pressure.

7. The flaskless molding machine of claim 6, further comprising an optional cylinder system adapted to be actuated by variable hydraulic pressure for providing a driving force to a driven part of said flaskless molding machine, and wherein said sensors of said measuring means further includes a sensor for measuring the hydraulic pressure of said optional cylinder system.

8. The flaskless molding machine of claim 7, wherein said further cylinder system provides said driving force to said upper and lower squeeze members.

9. The flaskless molding machine of claim 7, wherein said molding machine uses two pairs of said flasks in which one cope flask and one drag flask are formed as one pair such that the molding machine is adapted to alternately make molds with said two pairs of said flasks, and
wherein said optional cylinder system includes a third cylinder system for generating a driving force to remove said cope flask that is used to make said upper mold that is contained therein, from said match plate, and a fourth cylinder system for generating a driving force to strip said upper and lower molds from said one pair of flasks that has been separated from said match plate.

10. The flaskless molding machine of claim 7, wherein said optional cylinder system includes clustered cylinders comprising a plurality of hydraulic cylinders.
